(19) United States
(12) Patent Application Publication
(10) Pub. No.: US 2007/0060078 A1
(43) Pub. Date: Mar. 15, 2007

(54) Last inch communication system

(76) Inventors: Douglas Gene Lockie, Los Gatos, CA (US); Thomas Nello Giaccherini, Carmel Valley, CA (US)

Correspondence Address: Giaccherini, Post Office Box 1146, Carmel Valley, CA, 93924, US

(21) Appl. No.: 11/483,409

(22) Filed: Jul. 7, 2006

Related U.S. Application Data
(60) Provisional application No. 60/698,620, filed on Jul. 12, 2005.

(51) Int. Cl. G06F 3/033

(52) U.S. Cl. 455/130

(57) ABSTRACT

Methods and apparatus for a high speed, highly directional, wireless communication system are disclosed. The high speed wireless links (16) are accomplished using relatively narrow beams (<1°) that allow for virtually unlimited links in any geographic area, and which allow virtually any individual or company to implement fiber-speed links qui ckly and at a very low cost compared to the expense of installing an optical fiber link. Specifically, this new high speed communications service may be carried out at the 71-76 GHz, 81-86 GHz, and/or 92-95 GHz frequency bands. The data link is extended inside each building (10, 14) using internal power lines (24) and power outlets (26) to connect a variety of data devices (36). In an alternative embodiment, a wireless access point (34) may be connected to a power outlet (26) to provide a wireless hotspot for wireless data devices (36).

### CROSS-REFERENCE TO A RELATED PATENT APPLICATION & CLAIMS FOR PRIORITY

This Non-Provisional Patent Application is related to Pending U.S. Provisional Patent Application Ser. No. 60/698,620, which was filed on 11 Jul. 2005. The Applicant hereby claims the benefit of priority under Sections 119 and/or 120 of Title 35 of the United States Code of Laws for any subject matter which is commonly disclosed in the Pending Provisional Patent Application and in the Present Non-Provisional Patent Application.

### FIELD OF THE INVENTION

The present invention pertains to methods and apparatus for a high speed, wireless communication system. More particularly, one preferred embodiment of the invention employs highly directional, point-to-point radio links that may be used for communications among a number of buildings or other generally fixed sites or installations. Within each building, communications are delivered over the existing power lines in the buildings.

### BACKGROUND OF THE INVENTION

Providing high speed communication links among a set of buildings can be extremely expensive. Conventional links may include wire or optical fiber cables. Obtaining rights-of-way and permits to build these in-ground facilities can be costly and time consuming. Conventional microwave links operate at relatively slow speeds, and may cause unwanted interference among the many radio receivers that are installed in and on the buildings.

The difficulty and expense of supplying broadband data links at the edges of the communication network has been described as the “Last Mile Problem.” Only about five percent of the 750,000 commercial buildings in the United States are connected by optical fibers. Businesses that reside in the remaining ninety-five percent of commercial buildings need the high speed service offered by fiber, but are unable to obtain a fiber connection, can not afford a fiber connection, or do not have the time to wait for the installation of a fiber connection.

No current commercially-available device or system provides a readily available, relatively inexpensive high speed connection for a cluster of buildings configured in a campus-style environment. The development of such a system would constitute a major technological advance, and would satisfy long felt needs and aspirations in the telecommunications business.

### SUMMARY OF THE INVENTION

The present invention provides a high speed communication system for generally fixed installations, such as clusters of buildings. In one embodiment of the invention, two or more buildings are linked by relatively high frequency and highly directional wireless emissions. In one particular embodiment of the invention, these emissions are propagated in the 71-76 GHz, 81-86 GHz and 93-95 GHz frequency bands. The use of these extremely high frequency bands enables point-to-point communications, and generally eliminates interference with other communication systems.

Within each building among a group of buildings, the existing power lines and outlets are employed to provide Gigabit speed data connections. The present invention not only solves the “Last Mile Problem,” but also solves the “The Last Inch Problem,” since the data connections are extended all the way to the users on every floor and in every room in the building.

An appreciation of the other aims and objectives of the present invention, and a more complete and comprehensive understanding of this invention, may be obtained by studying the following description of preferred and alternative embodiments, and by referring to the accompanying drawings.

### A BRIEF DESCRIPTION OF THE DRAWINGS

FIG. 1 is an illustration of a group of buildings. The tall building in the center of the group is equipped with antennas which transmit and receive signals to and from the surrounding buildings.

FIG. 2 furnishes a slightly more detailed view of two buildings with high speed wireless links that use roof-mounted and window mounted antennas.

FIG. 3 offers a view of a window-mounted antenna.

FIG. 4 supplies a view of roof-mounted antenna.

FIG. 5 presents a graph of signal attenuation versus signal frequency.

FIG. 6 supplies a schematic diagram of two transceivers that establish a wireless link between two generally fixed sites.

FIG. 7 is a schematic diagram of a radio that may be used to implement one embodiment of the present invention.

FIG. 8 is an illustration of a building which is equipped with a roof-top antenna that provides Gigabit speed communications for persons within the building.

FIG. 9 shows a person inside the building operating a computer which is connected to a standard 120 VAC power outlet. Both conventional electrical power and high speed data signals are conveyed to this conventional power outlet.

### A DETAILED DESCRIPTION OF PREFERRED & ALTERNATIVE EMBODIMENTS

I. Overview of the Invention

The present invention comprises methods and apparatus for furnishing high speed wireless communications. In one embodiment of the invention, wireless links are established between or among a group of closely spaced buildings, and data connections are then extended into the buildings over conventional power lines.

In this Specification and in the Claims that follow, the term “building” refers to a generally fixed site, structure or apparatus. The term “antenna” encompasses any means for emitting and/or receiving electromagnetic or optical energy or other signals. A “transmitter” is any device or means for sending, conveying or emanating a signal, while a “receiver” is any device or means for sensing, detecting or receiving a signal. A “transceiver” is capable of both sending and receiving. A “radome” is any device that partially or completely encloses and protects an antenna.

A “network” comprises any combination, aggregation or assembly of links between nodes, terminals or some other source of signal, data or intelligence. A network may include a public switched telephone network (PSTN), the Internet, or a private network.

A “signal” encompasses any form of intelligence, language, data, content, sensation, representation or other form of communication.

II. Preferred & Alternative Embodiments of the Invention

In 2003, the United States Federal Communications Commission (FCC) authorized new spectrum for high speed wireless communications. These new rules provide 13,000 MHz of spectrum, enabling multi-gigabit-per-second communications. These communications are implemented in accordance with highly directional point-to-point licenses, which assure link integrity. These high speed wireless links are accomplished using relatively narrow beams (<1°) that allow for virtually unlimited links in any geographic area, and which allow virtually any individual or company to implement fiber-speed links quickly and at a very low cost compared to the expense of installing an optical fiber link.

Specifically, this new high speed communications service may be carried out at the 71-76 GHz, 81-86 GHz, and/or 92-95 GHz frequency bands. These are the only bands that will enable carrier-grade multi-giga-bit-per-second communications for the entire last mile. The physics associated with high-speed wireless communications require a large amount of spectrum with the lowest potential for atmospheric resistance (particularly in terrestrial environments).

The present invention utilizes these frequency bands to provide reliable point-to-point two-way communications at up to 2.48 Gbps with 99.999% weather availability for about a mile or more throughout most of the United States. Alternative embodiments of the invention enable last-mile communications at 10 Giga-bits per second or OC-192. The present invention incorporates point-to-point, highly directional system architectures that deliver up to 100 times better “link margin” or 20 dB more power than other systems. The superior “link margin” offered by the present invention enables significantly higher link performance, greater link availability, superior link range, and a smaller installation footprint than alternative devices can deliver. The present invention spans the entire last mile with 99.999% availability, costs a fraction of fiber and can be deployed within hours. These benefits improve network availability and resiliency to failure, while reducing the costs of installation, network integration, and maintenance. Some applications of the invention include, but are not limited to:

Fiber (Backbone) POP Access

Redundant Access—Network Diversity

Enterprise Campus Connectivity

Local Area Network (LAN) Extension

Local Loop

Metropolitan Area Network (MAN)

Wide Area Network (WAN) Access

Central Office Bypass

Storage Access (SAN & NAS)

Wireless Backhaul (3G & 4G)

High Definition Video

Some benefits and features offered by the invention include, but are not limited to:

Reduce cost by lowering or eliminating fiber deployment and access charges

Reduce risk by increasing network resiliency through diverse access paths

Reduce time-to-market by reducing network backlog and deployment time

Links have very low probability of interception due to a narrow transmission beam-width (less than one degree)

High security levels by teaming with leading edge encryption providers to further improve security of transmissions

Speeds: from 1.25 Gbps to 10 Gbps

Redundancy: simplex single links to duplex auto-failover systems
Security: multiple encryption levels available as well as network encryption reliance

Antennas: sizes ranging from 18 inches to four feet across, depending on network design requirements

Protocols: supporting virtually any protocol, just like a fiber splice

Power: multiple power sources available including AC, DC and fuel cell for remote operation

Mounting Options: multiple options including pole, tower, window (inside or outside) and wall mounting

III. A Detailed Description of a Particular Embodiment of the Invention

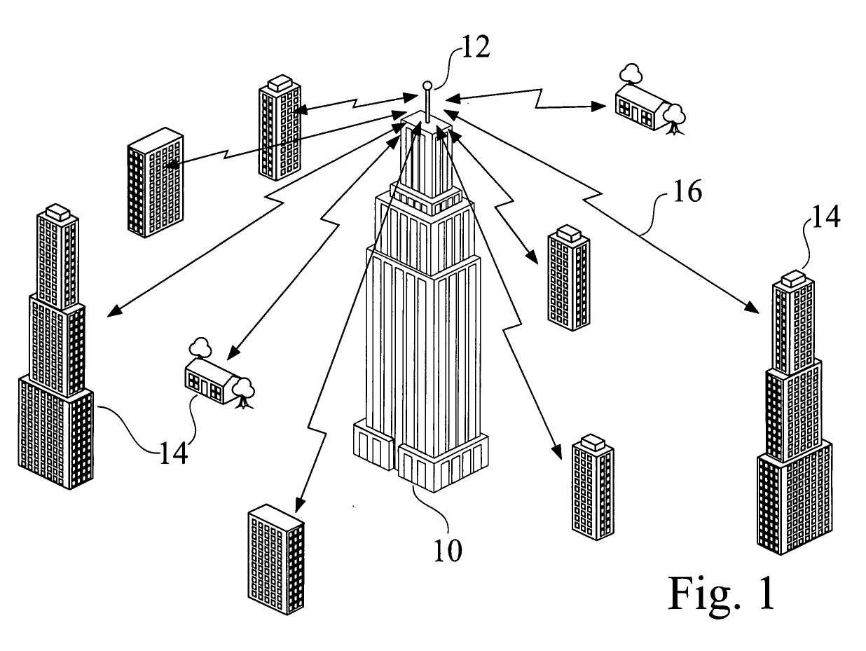

FIG. 1 provides a schematic view of one generalized embodiment of the invention. A first building 10 is equipped with an antenna 12. Other buildings 14 situated generally around the first building 10 are also equipped with antennas 12. These other buildings 14 comprise any generally fixed structure, and may include office buildings, retail establishments, schools, homes or any other site that requires high speed communications. These antennas 12 be mounted on the outside or the inside of the buildings 10, 14. All the antennas 12 are carefully aimed and aligned to provide highly directional, point-to-point wireless links 16. These highly directional links 16 avoid interference with other radio devices.

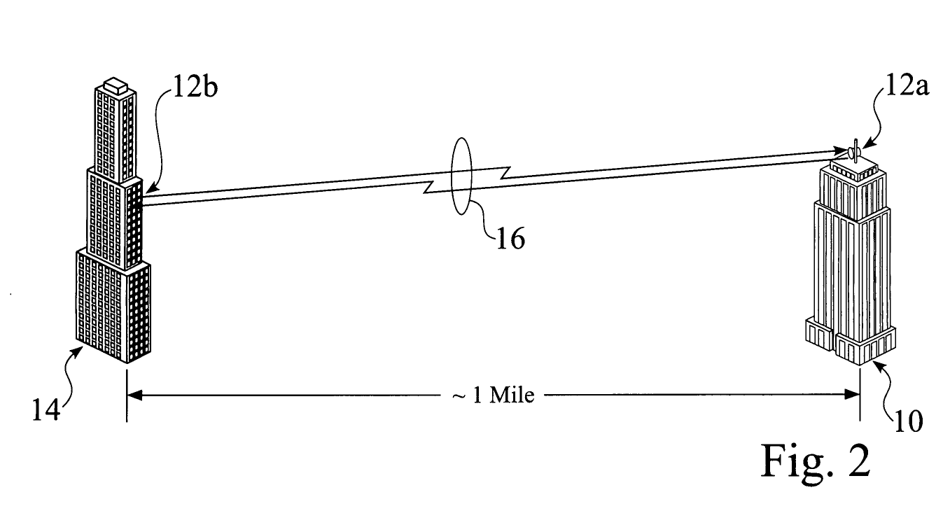

FIG. 2 exhibits a wireless link 16 between two buildings 10 and 14. A roof-mounted antenna 12a is deployed on building 10, while a window-mounted antenna 12b is affixed to building 14. In this embodiment of the invention, the wireless link 16 operates over a range of about one mile or more.

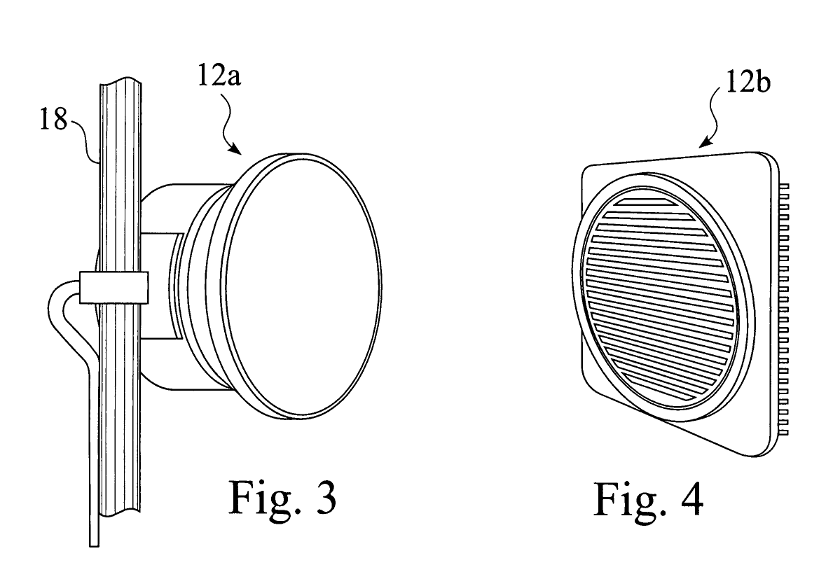

FIG. 3 offers a detailed view of the window-mounted antenna 12b, while FIG. 4 offers a detailed view of a roof-mounted antenna 12a, which is mounted on a pole 18.

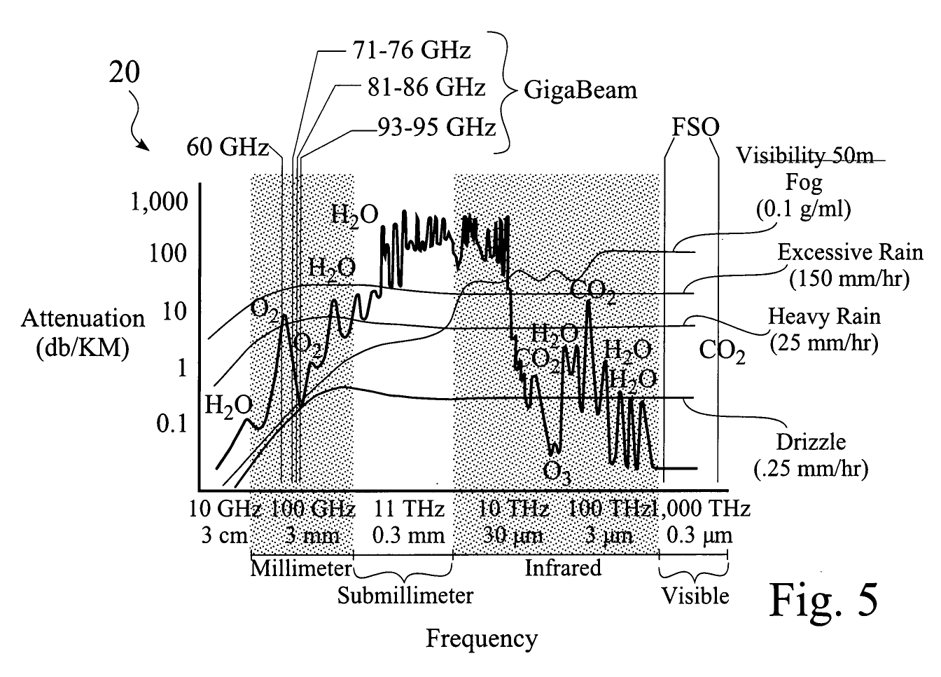

FIG. 5 furnishes a plot 20 of signal attenuation versus signal frequency. This plot 20 shows the various levels of signal attenuation measured in decibels per kilometer which result from a variety of levels of precipitation, such as drizzle, heavy rain, excessive rain, and fog. These bad weather attenuation levels are shown for the preferred frequency bands for the present invention, 71-76 GHz, 81-86 GHz and 93-95 GHz.

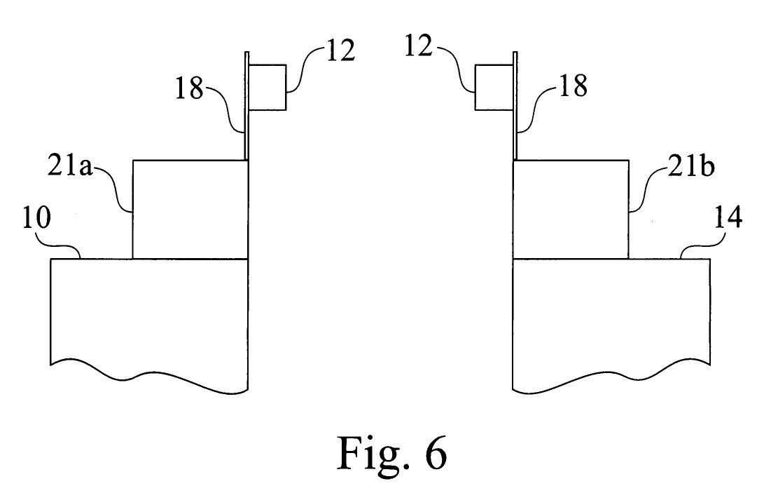

FIG. 6 is a schematic diagram that depicts two radio transceivers 21a and 21b which are each connected to an antenna 12 that may be used to establish a wireless link 16 between two generally fixed sites 10, 14. These transceivers 21 may be located inside or outside the buildings 10, 14 and are capable of transmitting and/or receiving. In some implementations of the invention, one transceiver 21 may transmit nearly all of the time, while the other may receive nearly all of the time. When recited in the Claims that follow, the term “transceiver means” is intended to encompass any apparatus that may provide any combination of transmitting and/or receiving functions, including the situation where a first transceiver in a pair of transceivers transmits generally all the time, and a second receives generally all the time. In an alternative embodiment of the invention, a first transceiver may include only a transmit radio, while a second transceiver may include only a receive radio.

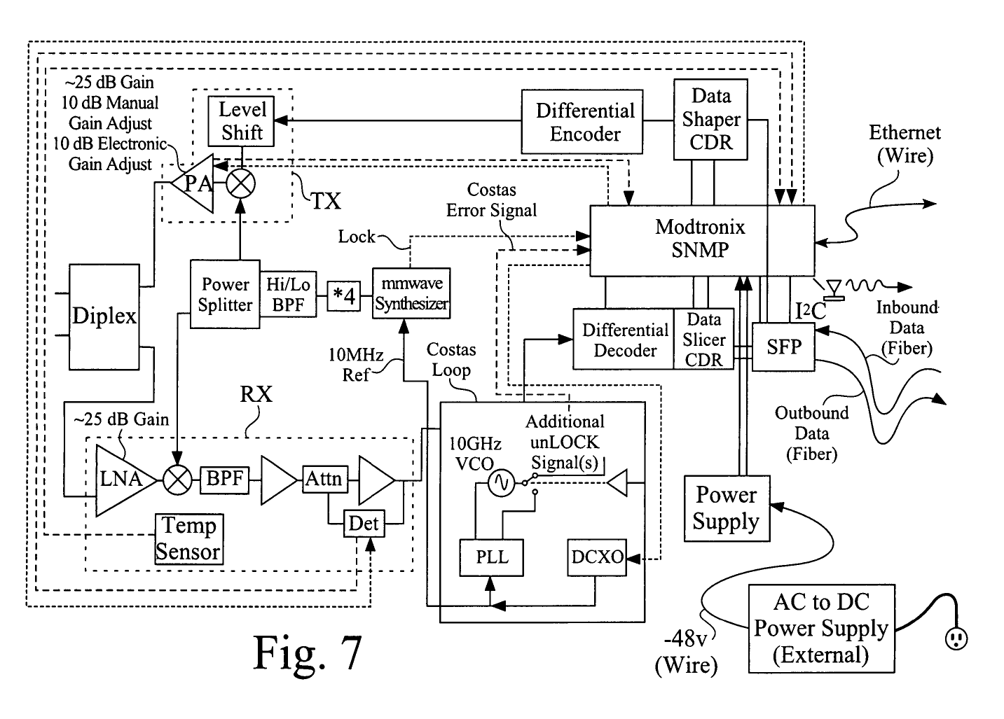

FIG. 7 presents a schematic diagram of one particular radio that may be used in the transceivers 21a and 21b. In one embodiment of the invention, the transceivers 21a and 21b comprise radios that are capable of operating in frequency bands that are at and/or above 71 GHz. The use of these frequency bands, in combination with the use of appropriately scaled antennas 12, produce narrow, highly-directional beams which subtend generally less than one degree of arc. These narrow beams assure that radio signals produced by one matched set of two antennas do not interference with other radio devices that may be nearby. In one embodiment of the invention, the transceivers 21a and 21b and antennas 12 are configured to provide a wireless link 16 that operates at a data rate generally above one Gigabit per second. In one embodiment of the invention, the wireless link 16 operates over a range of approximately one mile. The combination of transceivers 21a and 21b and antennas 12 is designed to operate in accordance with a point-to-point license authorized by the Federal Communications Commission to assure link integrity.

IV. Extending Data Links Over Power Lines

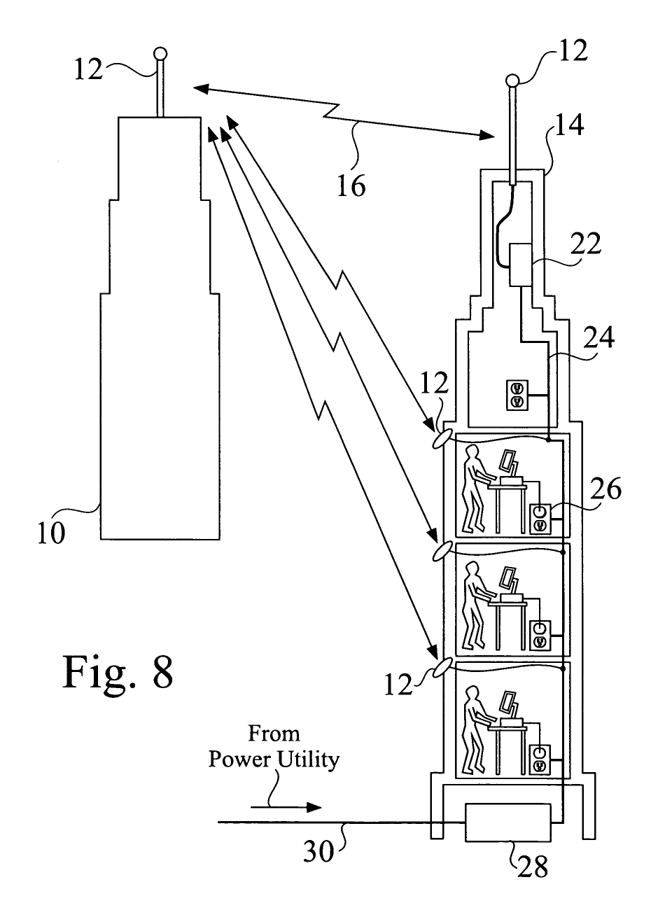

FIG. 8 furnishes a simplified pictorial cut-away view of two buildings 10 and 14. A pair of antennas 12 mounted on the roof of each building 10 and 14 provide a wireless link 16 in accordance with the present invention. Once the data link is received in each building, the link is extended down into the building through a connection box 22, and then throughout the interior of the building using conventional power lines 24 and power outlets 26. The basement of the building encloses a connection box 28 which receives electricity via a connection to the utility power grid 30.

In an alternative embodiment of the invention, the wireless link 16 may be supplied to each individual section or floor of the building using additional antennas 12, as shown in FIG. 8. This alternative may enhance the performance of the data link by avoiding transformers and other devices installed along the power lines in the building.

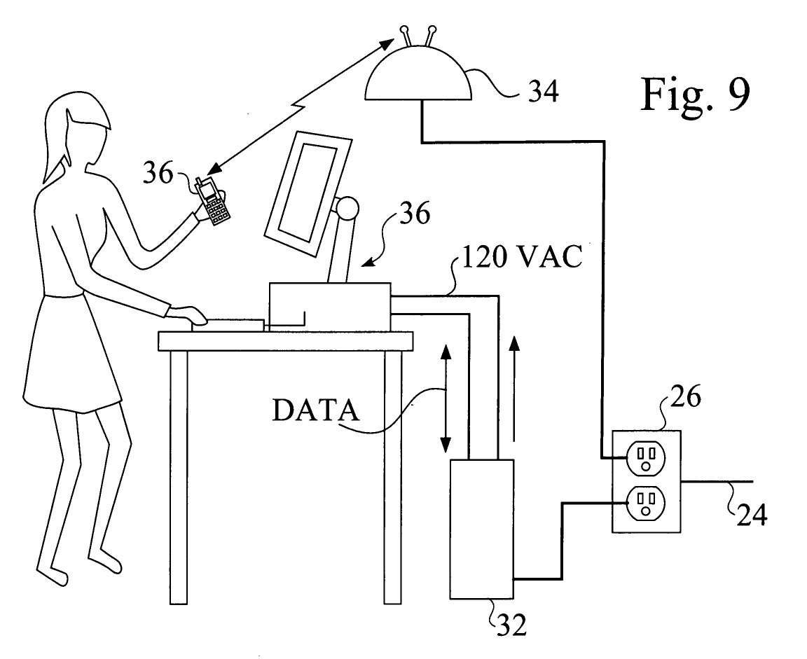

FIG. 9 shows a person inside the building using a computer or some other data device 36 which receives both nominal 120 VAC at 60 Hz power and data over the same internal power line 24 through a conventional power outlet 26 and a modem 32. Systems that enable data links over power lines are available in the commercial marketplace. An example of one such system is sold by Telkonet, Inc. of Germantown, Md. Although the power outlet 26 shown in FIG. 9 is a conventional three prong socket with hot, neutral and ground terminals, the invention may be implemented with any power outlet configuration, including 240 volt outlets and the variations found in countries outside the United States.

As shown in FIG. 9, a wireless access point 34 may be connected to the power outlet 26. This wireless access point 34 is a radio which is configured to transmit and/or receive data from the power line 24, and then to broadcast the data using Wi-Fi, Wi-Max, Bluetooth or any other suitable transmission configuration. Any number of wireless devices 36, including, but not limited to, a personal computer, laptop computer, cellular telephone, a pager, a Blackberry™ or a personal digital assistant may be used to communicate with the wireless access point 34.

Although this detailed description of one particular implementation of the invention incorporates unique design features, characteristics, geometries, and numerical specifications, this description is provided only as an illustration, and is not intended to limit the scope of the Claims which follow this Specification.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Last Inch Communication System that have been disclosed above are intended to educate the reader about preferred embodiments of the invention, and are not intended to constrain the limits of the invention or the scope of Claims.

### LIST OF REFERENCE CHARACTERS

10 First building
12 Generalized antenna
12a Antenna mounted on pole
12b Antenna mounted on window
14 Second building
16 Wireless link
18 Pole
20 Plot of frequency v. attenuation
21a Transceiver
21b Transceiver
22 Connection box to antenna
24 Interior power line
26 Power outlet
28 Connection box to utility power cables
30 Main power line from utility
32 Modem
34 Wireless Access Point
36 Data device

What is claimed is:

1. A method comprising the steps of:
providing a first radio transceiver (21a);
providing a second radio transceiver (21b);
said first and said second transceiver (21a, 21b) operating at a frequency generally greater than 70 GHz;
connecting one of said transceivers (21a, 21b) to a conductor (24); said conductor (24) generally for conveying electrical power; and
connecting a data device (32) to said conductor (24) to receive data.

2. A method as recited in claim 1, in which said first radio transceiver (21a) is mounted on a building (10).

3. A method as recited in claim 1, in which said second radio transceiver (21b) is mounted on a building (14).

4. A method as recited in claim 1, in which said first and said second radio transceivers (21a & 21b) operate in accordance with a point-to-point license authorized by the Federal Communications Commission to assure link integrity.

5. A method as recited in claim 1, in which said conductor (24) is a power line.

6. A method as recited in claim 5, in which said power line (24) conveys an alternating current which is nominally provided at 120 volts and 60 Hz.

7. A method as recited in claim 5, in which said power line (24) is inside a building.

8. A method as recited in claim 1, in which said conductor (24) is attached to a power outlet (26).

9. A method as recited in claim 8, in which said data device (32) is connected to said power outlet (26).

10. A method as recited in claim 1, in which said data device (32) is a personal computer.

11. A method as recited in claim 1, in which said data device (32) is a wireless access point (34).

12. A method as recited in claim 11, in which said wireless access point (34) communicates with a wireless device (36).

13. A method as recited in claim 11, in which said wireless access point (34) communicates with a cellular telephone (36).

14. A method as recited in claim 11, in which said wireless access point (34) communicates with a personal digital assistant (36).

15. A method comprising the steps of:
providing a first radio transceiver (21a);
providing a second radio transceiver (21b);
said first and said second transceiver (21a, 21b) operating at a frequency generally greater than 70 GHz;
connecting one of said transceivers (21a, 21b) to a conductor (24); said conductor (24) generally for conveying electrical power; and
connecting a data device (32) to said conductor (24) to transmit data.

16. A method as recited in claim 1, in which said first radio transceiver (21a) is mounted on a building (10).

17. A method as recited in claim 1, in which said second radio transceiver (21b) is mounted on a building (14).

18. A method as recited in claim 1, in which said first and said second radio transceivers (21a & 21b) operate in accordance with a point-to-point license authorized by the Federal Communications Commission to assure link integrity.

19. A method as recited in claim 1, in which said conductor (24) is a power line.

20. A method as recited in claim 19, in which said power line (24) conveys an alternating current which is nominally provided at 120 volts and 60 Hz.

21. A method as recited in claim 19, in which said power line (24) is inside a building.

22. A method as recited in claim 1, in which said conductor (24) is attached to a power outlet (26).

23. A method as recited in claim 22, in which said data device (32) is connected to said power outlet (26).

24. A method as recited in claim 1, in which said data device (32) is a personal computer.

25. A method as recited in claim 1, in which said data device (32) is a wireless access point (34).

26. A method as recited in claim 25, in which said wireless access point (34) communicates with a wireless device (36).

27. A method as recited in claim 25, in which said wireless access point (34) communicates with a cellular telephone (36).

28. A method as recited in claim 25, in which said wireless access point (34) communicates with a personal digital assistant (36).

29. An apparatus comprising:
a first and a second transceiver means (21); said first and said second transceiver means (21) for operating at a frequency generally above 70 GHz;
said first transceiver means (21) being located on a first building (10);
said second transceiver means (21) being located on a second building (14);
said first and said second transceiver means (21) for providing a wireless link (16) between said first and second fixed sites (10, 14) at a data rate generally above one Gigabit per second;
said first and second transceiver means (21) working in combination with said antennas (12) to utilize narrow beams which subtend generally less than one degree;
said first and said second transceiver means (21) operating in accordance with a point-to-point license authorized by the Federal Communications Commission to assure link integrity;
said second building (14) including an internal power line (24) and a power outlet (26);
said second transceiver means (21) being connected to said internal power line (24) and to said power outlet (26) to provide a high speed data connection for a user in said second building (14).

30. An apparatus as recited in claim 29, in which said internal power line (24) conveys an alternating current that is nominally provided at 120 volts and 60 Hz.

31. An apparatus as recited in claim 29, further comprising a data device (32) connected to said power outlet (26).

32. A method as recited in claim 29, in which said data device (32) is a personal computer.

33. A method as recited in claim 29, in which said data device (32) is a wireless access point (34).

34. A method as recited in claim 33, in which said wireless access point (34) communicates with a wireless device (36).

35. A method as recited in claim 33, in which said wireless access point (34) communicates with a cellular telephone (36).

36. A method as recited in claim 33, in which said wireless access point (34) communicates with a personal digital assistant (36).
